(19) United States
(12) Patent Application Publication
(10) Pub. No.: US 2015/0102758 A1
(43) Pub. Date: Apr. 16, 2015

(54) MOTOR DRIVE CONTROLLER, MOTOR DRIVE CONTROL METHOD AND MOTOR SYSTEM USING THE SAME

(71) Applicant: SAMSUNG ELECTRO-MECHANICS CO., LTD., Suwon (KR)

(72) Inventor: Su Yeon HAN, Suwon (KR)

(73) Assignee: SAMSUNG ELECTRO-MECHANICS CO., LTD., Suwon (KR)

(21) Appl. No.: 14/159,732

(22) Filed: Jan. 21, 2014

(30) Foreign Application Priority Data
Oct. 15, 2013 (KR) 10-2013-0122774

(51) Int. Cl. H02P 27/06

(52) U.S. Cl. CPC H02P 27/06
USPC 318/504

(57) ABSTRACT

There are provided a motor drive controller, a motor drive control method, and a motor system using the same. The motor drive controller may include: a voltage-vector providing unit generating voltage vectors having the same magnitude; an inverter unit applying the voltage vectors to multiple phases of a motor device; and a rotor position determining unit detecting currents generated in the motor device by the voltage vectors and determining a position of a rotor of the motor device by using the currents and rotation information of the motor device.

### CROSS-REFERENCE TO RELATED APPLICATION

This application claims the benefit of Korean Patent Application No. 10-2013-0122774 filed on Oct. 15, 2013, with the Korean Intellectual Property Office, the disclosure of which is incorporated herein by reference.

### BACKGROUND

The present disclosure relates to a motor drive controller, a motor drive control method, and a motor system using the same.

Following the development of motor technology, motors having various sizes have been used in a wide range of technical fields.

Generally, a motor is driven by rotating a rotor using a permanent magnet and a coil having polarities changed according to a current applied thereto. Early forms of motors included a brush-type motor having a coil on a rotor, which has a problem of the brush wearing out or sparks occurring due to the driving of the motor.

For this reason, various types of brushless motors are being commonly used today. A brushless motor is a direct current motor that eliminates mechanical contact parts such as a brush and a commutator and instead uses electronic commutation elements. Typically, a brushless motor may include coils each corresponding to the respective phases, a stator generating a magnetic force by a phase voltage in each of the coils, and a rotor formed of a permanent magnet and rotating by the magnetic force of the stator.

In order to control the driving of such brushless motors, it is necessary to locate the position of the rotor to alternately provide the phase voltage. In order to locate the position of the rotor, a method of using back electromotive force to estimate the position of the rotor is widely used.

However, the back electromotive force may accurately estimate the position of the rotor only if the motor operates above a certain speed. Accordingly, it is difficult to accurately estimate the position of the rotor by using the back electromotive force when the motor is initially starting up or operating at a low speed.

Patent Document 1 discloses a moving method of a brushless DC motor for an ODD without a hall sensor and Patent Document 2 discloses an estimation method of an initial position of a rotor and a starting method of a brushless DC motor without a position sensor. However, the documents fail to overcome the above-mentioned problem.

### RELATED ART DOCUMENTS

(Patent Document 1) Korean Patent Laid-Open Publication No. 10-2008-0079142
(Patent Document 2) Korean Patent Laid-Open Publication No. 10-2006-0011714

### SUMMARY

An aspect of the present disclosure may provide a motor drive controller and a motor drive control method capable of more accurately determining the position of a rotor while preventing reverse rotation by taking into account rotation information of a motor device in addition to currents derived by applying voltage vectors having the same magnitude, and a motor system using the same.

According to an aspect of the present disclosure, a motor drive controller may include: a voltage-vector providing unit generating voltage vectors having the same magnitude; an inverter unit applying the voltage vectors to multiple phases of a motor device; and a rotor position determining unit detecting currents generated in the motor device by the voltage vectors and determining a position of a rotor of the motor device by using the currents and rotation information of the motor device.

The voltage vectors may be short-pulses having the same voltage level.

The rotor position determining unit may check a first phase corresponding to a first current which has the largest value among the currents and may determine the position of the rotor based on the rotation information in addition to the first phase.

If a pair of currents has the largest value among the currents, the rotor position determining unit may determine that the rotor is located in a phase located in the rotation direction between first and second phases corresponding to the pair of currents.

The rotor position determining unit may include: a current detector connected to the multiple phases of the motor device to detect the currents flowing in the phases; a current comparator comparing amplitudes of the currents; and a position determiner determining the position of the rotor by using the comparison results from the current comparator and the rotation information.

The position determiner may determine the position of the rotor based on the rotation information in addition to the first phase corresponding to a first current having the largest value among the currents.

According to another aspect of the present disclosure, a motor system may include: a motor device having multiple phases; and a motor drive controller applying voltage vectors to the phases and determining a position of a rotor of the motor device by using currents generated in the motor device by the voltage vectors and rotation information of the motor device.

The motor drive controller may include: a voltage-vector providing unit generating voltage vectors having the same magnitude; an inverter unit applying the voltage vectors to multiple phases of a motor device; and a rotor position determining unit detecting currents generated in the motor device by the voltage vectors and determining a position of a rotor of the motor device by using the currents and rotation information of the motor device.

The rotor position determining unit may check a first phase corresponding to a first current which has the largest value among the currents and may determine the position of the rotor based on the rotation information in addition to the first phase.

If a pair of currents has the largest value among the currents, the rotor position determining unit may determine that the rotor is located in a phase located in the rotation direction between first and second phases corresponding to the pair of currents.

The rotor position determining unit may include: a current detector connected to the multiple phases of the motor device to detect the currents flowing in the phases; a current comparator comparing amplitudes of the currents; and a position determiner determining the position of the rotor by using the comparison results from the current comparator and the rotation information.

The position determiner may determine the position of the rotor based on the rotation information in addition to the first phase corresponding to a first current having the largest value among the currents.

According to another aspect of the present disclosure, a motor drive control method performed in a motor drive controller controlling driving of a motor device may include: generating voltage vectors having the same magnitude; applying the voltage vectors to multiple phases of the motor device; and detecting currents generated in the motor device by the voltage vectors and determining a position of a rotor of the motor device by using the currents and rotation information of the motor device.

The voltage vectors may be short-pulses having the same voltage level.

Determining the position of the rotor may include checking a first phase corresponding to a first current which has the largest value among the currents and determining the position of the rotor based on the rotation information in addition to the first phase.

Determining the position of the rotor may include determining, if a pair of currents has the largest value among the currents, that the rotor is located in a phase located in the rotation direction between first and second phases corresponding to the pair of currents.

Determining the position of the rotor may include: detecting currents flowing in the phases; comparing amplitudes of the currents; and determining the position of the rotor by using the comparison results and the rotation information.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of a motor system according to an exemplary embodiment of the present disclosure;

FIG. 2 is a diagram illustrating an example of such voltage vectors;

FIGS. 3 and 4 are diagrams illustrating examples of determining the position of a rotor at different positions;

FIG. 5 is a block diagram of the rotor position determining unit of FIG. 1 according to an exemplary embodiment;

FIG. 6 is a flow chart illustrating a motor drive control method according to an exemplary embodiment of the present disclosure; and

FIG. 7 is a flow chart illustrating step S630 of FIG. 6.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements

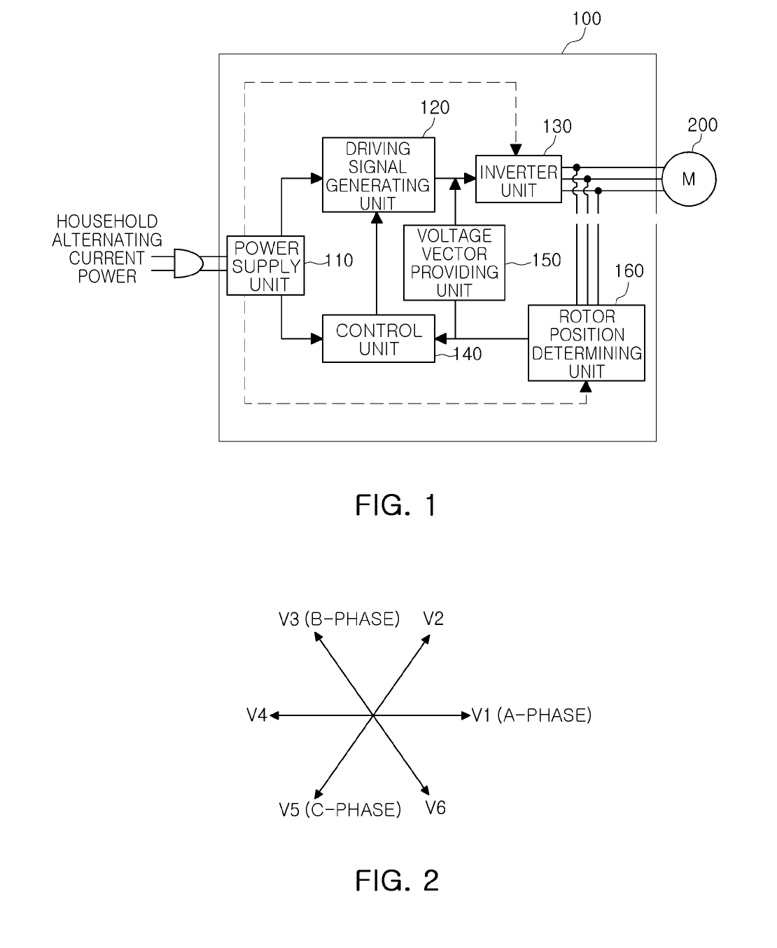

FIG. 1 is a block diagram of a motor system according to an exemplary embodiment of the present disclosure.

The motor device 200 may include multiple phases. The multiple phases may serve as a stator of motor device 200, and the motor device 200 may include a rotor rotated by the stator.

The motor drive controller 100 may control the starting or driving of the motor device 200 by locating the position of the rotor of the motor device 200.

The motor drive controller 100 may apply voltage vectors to the multiple phases of the motor device 200, and locate the position of the rotor of the motor device 200 using a plurality of currents generated in the motor device 200 by the voltage vectors, and rotation information.

Specifically, the motor drive controller 100 may include a power supply unit 110, a driving signal generating unit 120, an inverter unit 130, a control unit 140, a voltage-vector providing unit 150, and a rotor position determining unit 160.

The power supply unit 110 may supply power to each of the components in the motor drive controller 100. For example, the power supplying unit 110 may convert a household alternating current (AC) voltage into a direct current (DC) voltage to supply the converted DC voltage. In the illustrated example, the dashed lines represent a predetermined amount of power supplied from the power supply unit 110.

The driving signal generating unit 120 may generate a driving signal for driving the motor device 200 in order to control the operation of the inverter unit 130.

The inverter unit 130 may be switched on and off to drive the motor device 200. For example, the inverter unit 130 may convert a direct current voltage into a multi-phase (e.g., three-phase) voltage according to a predetermined signal provided from the driving signal generating unit 120. The inverter unit 130 may apply voltages of multiple phases to the coils in the motor device 200, each of the coils corresponding to the respective phases, such that the rotor of the motor device 200 may be operated.

In an exemplary embodiment, the inverter unit 130 may receive the voltage vectors from the voltage-vector providing unit 150 and apply them to the respective multiple phases of the motor device 200.

The control unit 140 may receive information on the position of the rotor of the motor device 200 from the rotor position determining unit 160 to control the driving of the motor device 200. Further, the control unit 140 may request the rotor position determining unit 160 to determine the position of the rotor if the motor device 200 is stopped or is operated at low speed.

The control unit 140 may start up the motor device 200 based on the position of the rotor provided from the rotor position determining unit 160. Although not shown in the drawings, the motor drive controller 100 may further include an element for detecting back electromotive force, such that once the motor device 200 is successfully started up, the control unit 140 may control the driving of the motor device 200 by locating the position of the rotor using detected back electromotive force.

The voltage-vector providing unit 150 and the rotor position determining unit 160 may determine the position of the rotor at an initial operation of the motor device 200.

The voltage-vector providing unit 150 may generate voltage vectors having the same magnitude and provide them to the inverter unit 130. The inverter unit 130 may then apply the received voltage vectors to each of the multiple phases of the motor device 200.

FIG. 2 is a diagram illustrating an example of such voltage vectors. The voltage vectors will be described in detail with reference to FIG. 2.

As shown in FIG. 2, the voltage vectors V1 to V6 may have the same level, or the same scalar value. In the shown example, the motor device 200 is a three-phase motor having A-phase, B-phase and C-phase, and thus two voltage vectors are required for each of the phases such that a total of six voltage vectors exist.

Further, the voltage vectors may be short-pulse voltages. Since the voltage vectors are used to locate the current position of the rotor, they should not cause the rotor to rotate. By applying the voltage vectors in the form of short-pulse voltages, influence on the rotor may be substantially avoided.

In an exemplary embodiment of the present disclosure, the voltage-vector providing unit 150 may provide voltage vectors such that there is an interval of 180 degrees between consecutive voltage vectors. In the example shown in FIG. 2, the voltage-vector providing unit 150 may provide the voltage vectors in the order of V1-V4-V6-V3-V5-V2.

Referring back to FIG. 1, the rotor position determining unit 160 may detect currents generated in the motor device 200 based on the voltage vectors applied to the motor device 200. That is, the rotor position determining unit 160 may detect current generated in each of the phases of the motor device 200 based on the voltage vectors. The rotor position determining unit 160 may determine the position of the rotor of the motor device 200 using the detected currents and rotation information of the motor device 200.

That is, the rotor position determining unit 160 may determine the position of the rotor by using the rotation information of the motor device 200 in addition to the currents generated by the voltage vectors. Here, the position of the rotor may correspond to the phase of the motor device 200 to which a driving voltage is applied. Subsequently, the resulting position of the rotor provided to the control unit 140 by the rotor position determining unit 160 may not be a current physical position of the rotor but may be phase information to which voltage is to be applied for starting up.

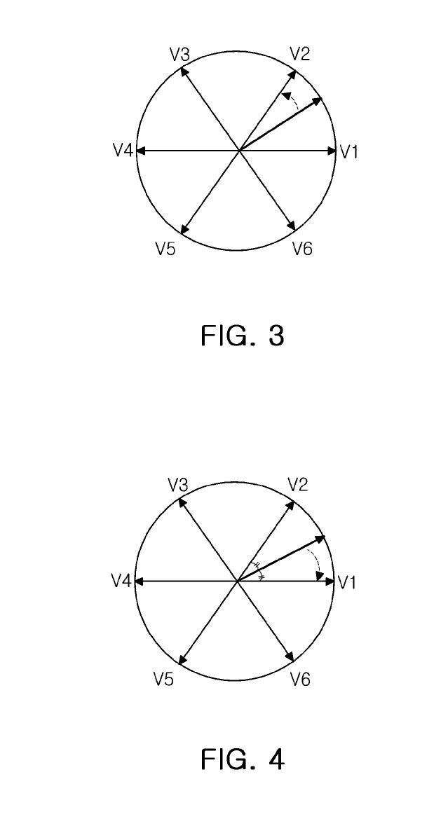

FIGS. 3 and 4 are diagrams illustrating examples of determining the position of the rotor at different positions. The rotor position determining unit 160 will be described in detail with reference to FIGS. 3 and 4.

In an exemplary embodiment of the present disclosure, the rotor position determining unit 160 may check a first phase corresponding to a first current which has the largest value among the currents and may determine the position of the rotor based on the rotation information in addition to the first phase.

Referring to FIG. 3, the bold arrow in FIG. 3 represents a rotor. The voltage vectors V1 to V6 are applied to each phase of the motor device 200 by the voltage-vector providing unit 150, and the rotor position determining unit 160 may detect currents corresponding to the vectors V1 to V6.

In the example shown in FIG. 3, the rotor is closest to the phase to which the voltage vector V2 is applied, so the current corresponding to the voltage vector V2 is detected to have the largest value. Further, the voltage vector V1 is also close to the rotor, so the current corresponding to the voltage vector V1 is also detected. Therefore, the voltage-vector providing unit 150 may learn that the rotor is located between the voltage vector V1 and the voltage vector V2 as shown, using the detected currents. In addition, since the value of the current corresponding to the voltage vector V2 is larger than that corresponding to the voltage vector V1, the voltage-vector providing unit 150 may learn that the rotor is closer to the voltage vector V2.

The rotor position determining unit 160 may determine the position of the rotor by using the rotation information of the motor device 200. In the example shown in FIG. 3, assuming that the rotation information of the motor device 200 is set to be a reverse direction (counterclockwise), the rotor position determining unit 160 may determine the position of the rotor in view of the rotation direction in addition to the position of the rotor (the position between the voltage vector V1 and the voltage vector V2 while being closer to the voltage vector V2) determined based on the currents. Therefore, when the rotation information is set to be the reverse direction, the rotor is expected to move toward the voltage vector V2, and the rotor position determining unit 160 may determine the voltage vector V2 as the position of the rotor and provide the control unit 140 with the position information.

In the example shown in FIG. 3, assuming that the rotation information of the motor device 200 is set to be a forward direction (clockwise), the rotor position determining unit 160 may determine the voltage vector V1 as the position of the rotor instead of the voltage vector V2.

In an exemplary embodiment of the present disclosure, if a pair of currents has the largest value among a plurality of currents, the rotor position determining unit 160 may determine that the rotor is located in a phase located in the rotation direction between first and second phases corresponding to the pair of currents.

In the example shown in FIG. 4, it can be seen that the rotor is located in the middle between the phases to which the voltage vector V1 and voltage vector V2 are applied. In this example, a pair of currents among the detected currents has the largest value. Therefore, the rotor position determining unit 160 may determine a phase located in the rotation direction between first and second phases corresponding to the pair of currents as the position information of the rotor. In the example shown in FIG. 4, the rotation direction is the forward direction (clockwise), so the rotor position determining unit 160 may determine the phase to which the voltage vector V1 is applied as the position of the rotor.

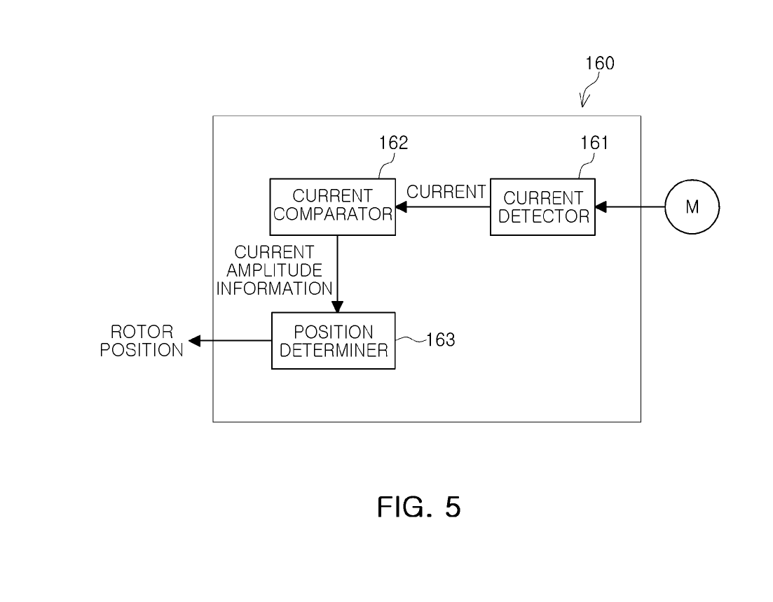

FIG. 5 is a block diagram of the rotor position determining unit of FIG. 2 according to an exemplary embodiment of the present disclosure.

Referring to FIG. 5, the rotor position determining unit 160 may include a current detector 161, a current comparator 162, and a position determiner 163.

The current detector 161 may be connected to the multiple phases of the motor device 200 to detect currents flowing in the phases. As described above, the currents may be derived by the voltage vectors applied to the multiple phases.

The current comparator 162 may compare the amplitudes of the currents detected by the current detector 161. The voltage vectors may be applied to the motor device 200 sequentially, so the current detector 161 may also detect currents sequentially. Accordingly, the current comparator 162 may include a storage unit to store information on the detected currents as necessary.

The position determiner 163 may determine the position of the rotor by using the comparison results from the current comparator 162 and the rotation information. A specific method of determining the position of the rotor has been described above with reference to FIGS. 3 and 4, and thus a description thereon will be omitted.

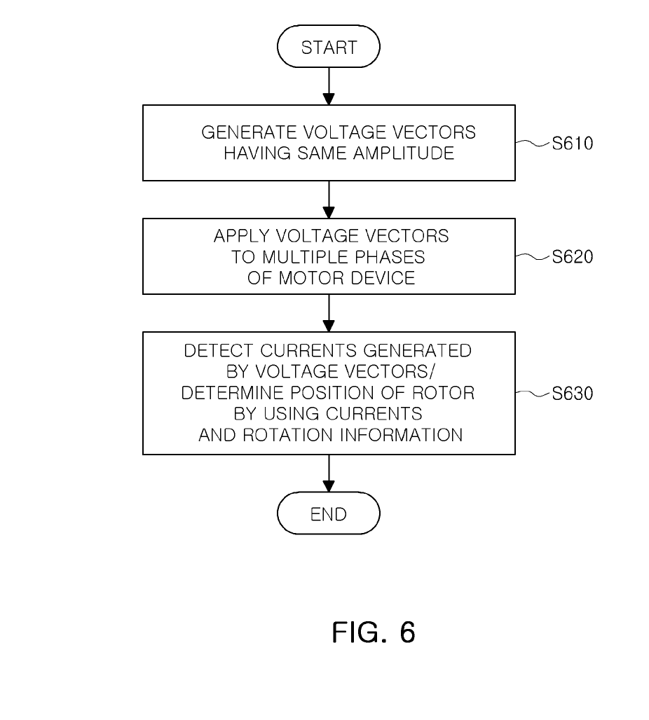

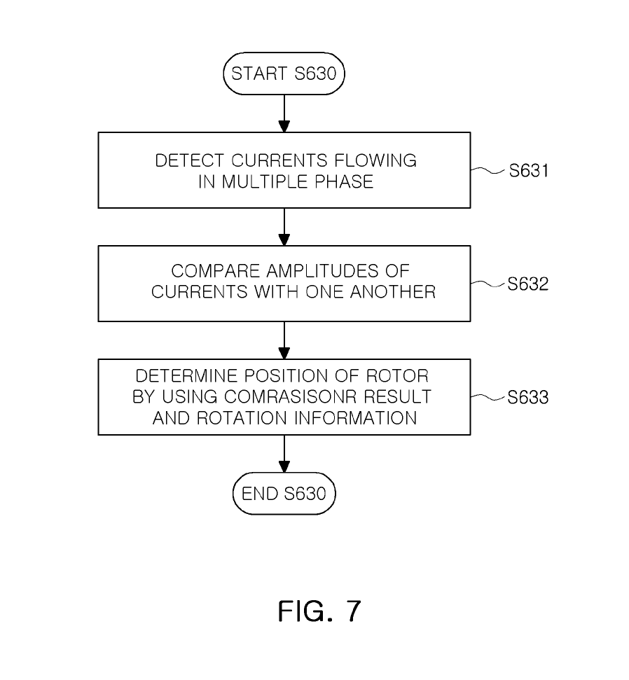

FIG. 6 is a flow chart illustrating a motor drive control method according to an exemplary embodiment of the present disclosure. FIG. 7 is a flow chart illustrating step S630 of FIG. 6.

Hereinafter, a motor driving control method according to an exemplary embodiment of the present disclosure will be described with reference to FIGS. 6 and 7. Since the motor drive control according to the exemplary embodiment is performed in the motor drive controller 100 described above with reference to FIGS. 1 through 5, redundant descriptions on the same or similar elements will be omitted.

Referring to FIGS. 1 and 6, a motor drive controller 100 may generate a plurality of voltage vectors having the same magnitude (S610).

Then, the motor drive controller 100 may apply each of the voltage vectors to the multiple phases of the motor device 200 (S620).

The motor drive controller 100 may detect currents generated in the motor device 200 by the voltage vectors and determine the position of the rotor of the motor device 200 using rotation information of the motor device 200 and the currents.

Here, the voltage vectors may be short-pulse voltages having the same voltage level.

In an exemplary embodiment of step S630, the motor drive controller 100 may check a first phase corresponding to a first current which has the largest value among the plurality of currents and determine the position of the rotor based on the rotation information in addition to the first phase.

In another exemplary embodiment of step S630, if a pair of currents has the largest value among the plurality of currents, the motor drive controller 100 may determine that the rotor is located in a phase located in the rotation direction between first and second phases corresponding to the pair of currents.

FIG. 7 illustrates an exemplary embodiment of step S630. Referring to FIG. 7, the motor drive controller 100 may be connected to the multiple phases of the motor device so that it may detect a plurality of currents flowing in the multiple phases, respectively (S631).

Then, the motor drive controller 100 may compare amplitudes of detected currents (S632) and determine the position of the rotor using the comparison results and rotation information (S633).

As set forth above, according to exemplary embodiments of the present disclosure, a position of a rotor may be accurately determined while preventing reverse rotation by taking into account rotation information of a motor device in addition to currents derived by applying voltage vectors having the same magnitude.

While exemplary embodiments have been shown and described above, it will be apparent to those skilled in the art that modifications and variations could be made without departing from the spirit and scope of the present disclosure as defined by the appended claims.

What is claimed is:

1. A motor drive controller comprising:
a voltage-vector providing unit generating voltage vectors having the same magnitude;
an inverter unit applying the voltage vectors to multiple phases of a motor device; and
a rotor position determining unit detecting currents generated in the motor device by the voltage vectors and determining a position of a rotor of the motor device by using the currents and rotation information of the motor device.

2. The motor drive controller of claim 1, wherein the voltage vectors are short pulses having the same voltage level.

3. The motor drive controller of claim 1, wherein the rotor position determining unit checks a first phase corresponding to a first current which has a largest value among the currents and determines the position of the rotor based on the rotation information in addition to the first phase.

4. The motor drive controller of claim 1, wherein if a pair of currents has a largest value among the currents, the rotor position determining unit determines that the rotor is located in a phase located in the rotation direction between first and second phases corresponding to the pair of currents.

5. The motor drive controller of claim 1, wherein the rotor position determining unit includes:
a current detector connected to the multiple phases of the motor device to detect the currents flowing in the phases;
a current comparator comparing amplitudes of the currents; and
a position determiner determining the position of the rotor by using the comparison results from the current comparator and the rotation information.

6. The motor drive controller of claim 5, wherein the position determiner determines the position of the rotor based on the rotation information in addition to the first phase corresponding to a first current having a largest value among the currents.

7. A motor system comprising:
a motor device having multiple phases; and
a motor drive controller applying voltage vectors to the multiple phases and determining a position of a rotor of the motor device by using currents generated in the motor device by the voltage vectors and rotation information of the motor device.

8. The motor system of claim 7, wherein the motor drive controller includes:
a voltage-vector providing unit generating voltage vectors having the same magnitude;
an inverter unit applying the voltage vectors to multiple phases of a motor device; and
a rotor position determining unit detecting currents generated in the motor device by the voltage vectors and determining a position of a rotor of the motor device by using the currents and rotation information of the motor device.

9. The motor system of claim 8, wherein the rotor position determining unit checks a first phase corresponding to a first current which has a largest value among the currents and determines the position of the rotor based on the rotation information in addition to the first phase.

10. The motor system of claim 8, wherein if a pair of currents has a largest value among the currents, the rotor position determining unit determines that the rotor is located in a phase located in the rotation direction between first and second phases corresponding to the pair of currents.

11. The motor system of claim 8, wherein the rotor position determining unit includes:
a current detector connected to the multiple phases of the motor device to detect the currents flowing in the multiple phases;
a current comparator comparing amplitudes of the currents; and
a position determiner determining the position of the rotor by using the comparison results from the current comparator and the rotation information.

12. The motor system of claim 11, wherein the position determiner determines the position of the rotor based on the rotation information in addition to the first phase corresponding to a first current having a largest value among the currents.

13. A motor drive control method performed in a motor drive controller controlling driving of a motor device, the method comprising:
generating voltage vectors having the same magnitude;
applying the voltage vectors to multiple phases of the motor device; and
detecting currents generated in the motor device by the voltage vectors and determining a position of a rotor of the motor device by using the currents and rotation information of the motor device.

14. The motor drive control method of claim 13, wherein the voltage vectors are short pulses having the same voltage level.

15. The motor drive control method of claim 13, wherein determining the position of the rotor includes checking a first phase corresponding to a first current which has a largest value among the currents and determining the position of the rotor based on the rotation information in addition to the first phase.

16. The motor drive control method of claim 13, wherein determining the position of the rotor includes determining, if a pair of currents has a largest value among the currents, that the rotor is located in a phase located in the rotation direction between first and second phases corresponding to the pair of currents.

17. The motor drive control method of claim 13, wherein determining the position of the rotor includes:
detecting currents flowing in the multiple phases;
comparing amplitudes of the currents; and
determining the position of the rotor by using the comparison results and the rotation information.
